(19) United States
(12) Patent Application Publication
(10) Pub. No.: US 2024/0178968 A1
(43) Pub. Date: May 30, 2024

(54) METHOD AND DEVICE USED FOR POSITIONING

(71) Applicants: Jin LIU, Shanghai (CN); Xiaobo ZHANG, Shanghai (CN)

(72) Inventors: Jin LIU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/520,578

(22) Filed: Nov. 28, 2023

(30) Foreign Application Priority Data
Nov. 30, 2022 (CN) 202211521628.7

(51) Int. Cl. H04L 5/00

(52) U.S. Cl. CPC H04L 5/0051; H04L 5/0064

(57) ABSTRACT

The present application discloses a method and device for positioning. A first node receives first configuration information; receives a first candidate signal on a first candidate time-domain resource block; and transmits a first positioning reference signal; the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal. This application helps enhance the positioning accuracy by addressing the synchronization of multiple SL PRS.

### CROSS REFERENCE TO RELATED APPLICATIONS

This application claims the priority benefit of Chinese Patent Application No.202211521628.7, filed on Nov. 30, 2022, the full disclosure of which is incorporated herein by reference.

### BACKGROUND

### Technical Field

The present application relates to transmission methods and devices in wireless communication systems, and in particular to a positioning-related scheme and device in wireless communications.

### Related Art

Positioning is an important aspect of application in wireless communications; the emergence of new applications like Vehicle to everything (V2X) or Industrial Internet of Things (IIoT) have posed higher demands on the accuracy or delay in respect of positioning. During the 3rd Generation Partner Project (3GPP) Radio Access Network (RAN) #94e Meetings, the project of studies on positioning enhancement has been approved.

### SUMMARY

According to the work plan of NR Release-18 (Rel-18), the technique of enhanced positioning is required for supporting Sidelink Positioning (SL Positioning), where the dominant SL positioning techniques include those based on SL RTT, SL AOA, SL TDOA and SL AOD, etc., and the performances of all these techniques are dependent on the measurement of Sidelink Positioning Reference Signal (SL PRS). The requirement for the accuracy of synchronization varies according to different positioning techniques. When using the technique of SL TDOA, multiple Anchor Nodes must be highly synchronized when transmitting multiple SL PRS respectively to a Target Node. According to a traditional synchronization priority order, multiple Anchor Nodes are likely to use different synchronization reference sources, which will lead to multiple SL PRS received by the Target Node out of sync and thus seriously affect the positioning accuracy of SL TDOA.

To address the above issue, the present application provides a method of determining the synchronization reference for the positioning reference signal. It should be noted that the description in the present application only takes V2X as a typical application scenario or example; this present application is also applicable to scenarios confronting similar problems, such as Public Safety and IIoT, where technical effects similar to those of NR V2X can be achieved. Besides, the present application is originally targeted at scenarios where the transmitter of radio signals for positioning measurements is moving, for instance, a piece of User Equipment (UE), but it can still be applicable to scenarios where the transmitter of radio signals for positioning measurements is fixed, e.g., a Road Side Unit (RSU). The adoption of a unified solution for various scenarios contributes to the reduction of hardcore complexity and costs. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Refer to 3GPP TS38.211, TS38.212, TS38.213, TS38.214, TS38.215, TS38.321, TS38.331, TS38.305, or TS37.355, if necessary, for a better understanding of the present application.

The present application provides a method in a first node for wireless communications, comprising:
receiving first configuration information;
receiving a first candidate signal on a first candidate time-domain resource block; and
transmitting a first positioning reference signal;
herein, the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

In one embodiment, a problem to be solved in the present application is: the issue of synchronization with multiple anchor nodes transmitting positioning reference signals for one target node.

In one embodiment, a problem to be solved in the present application is: how to make multiple SL PRS sent by multiple Anchor Nodes highly synchronized, thereby minimizing the impact on the SL TDOA technique.

In one embodiment, the method provided in the present application is: to set up a relationship between the synchronization reference and the positioning technique.

In one embodiment, the method provided in the present application is: to set up a relationship between the first candidate time-domain resource block and the first time-domain resource group.

In one embodiment, the method provided in the present application is: to set up a relationship between whether the first candidate time-domain resource block belongs to the first time-domain resource group and the synchronization reference for the first positioning reference signal.

In one embodiment, the method in the present application helps address the synchronization of multiple SL PRS.

In one embodiment, the method in the present application helps increase the accuracy of positioning.

According to one aspect of the present application, the above method is characterized in that the transmitter of the first candidate signal belongs to a target priority group, the target priority group being one of multiple candidate priority groups; whether the first candidate time-domain resource block belongs to the first time-domain resource group is used to determine a position of the target priority group among the multiple candidate priority groups; the synchronization reference for the first positioning reference signal is selected according to an order of the multiple candidate priority groups.

According to one aspect of the present application, the above method is characterized in that the first candidate signal carries a first identifier, and whether the first identifier is used to determine a position of the target priority group among the multiple candidate priority groups is related to whether the first candidate time-domain resource block belongs to the first time-domain resource group.

According to one aspect of the present application, the above method is characterized in that the first candidate signal carries a first identifier and first information, the first information indicating whether the transmitter of the first candidate signal is in coverage; at least one of the first identifier or the first information is used together with whether the first candidate time-domain resource block belongs to the first time-domain resource group to determine a position of the target priority group among the multiple candidate priority groups.

According to one aspect of the present application, the above method is characterized in comprising:
receiving second configuration information;
herein, the second configuration information comprises one of a first priority order, a gnss or a gnbEnb; the first priority order is used to determine the order of the multiple candidate priority groups.

According to one aspect of the present application, the above method is characterized in that the transmitter of the first candidate signal includes a target receiver of the first positioning reference signal, or, the transmitter of the first candidate signal includes a transmitter of a second positioning reference signal, the transmitter of the second positioning reference signal being non-co-located with the first node.

According to one aspect of the present application, the above method is characterized in comprising:
transmitting a first radio signal;
herein, the first radio signal comprises a first bit block, and a synchronization reference for the first radio signal is different from the synchronization reference for the first positioning reference signal.

According to one aspect of the present application, the above method is characterized in that the first node is a UE.

According to one aspect of the present application, the above method is characterized in that the first node is a relay node.

According to one aspect of the present application, the above method is characterized in that the first node is a Road Side Unit (RSU).

The present application provides a method in a second node for wireless communications, comprising:
receiving first configuration information;
receiving a first signaling;
transmitting a first candidate signal on a first candidate time-domain resource block; and
transmitting a second positioning reference signal;
herein, the first configuration information is used to indicate a first time-domain resource group, the first time-domain resource group comprising at least one time-domain resource block; the first signaling is used to determine whether the first candidate time-domain resource block belongs to the first time-domain resource group; a transmission timing of the first candidate signal is used to determine a transmission timing of the second positioning reference signal.

According to one aspect of the present application, the above method is characterized in that the second node belongs to a target priority group, the target priority group being one of multiple candidate priority groups; a position of the target priority group among the multiple candidate priority groups is related to whether the first candidate time-domain resource block belongs to the first time-domain resource group.

According to one aspect of the present application, the above method is characterized in that the first candidate signal carries a first identifier, and whether the first identifier is used to determine the position of the target priority group among the multiple candidate priority groups is related to whether the first candidate time-domain resource block belongs to the first time-domain resource group.

According to one aspect of the present application, the above method is characterized in that the first candidate signal carries a first identifier and first information, the first information indicating whether the second node is in coverage; the position of the target priority group among the multiple candidate priority groups is related to at least one of the first identifier or the first information and whether the first candidate time-domain resource block belongs to the first time-domain resource group.

According to one aspect of the present application, the above method is characterized in that a first priority order is indicated by second configuration information, and the first priority order is used to determine the order of the multiple candidate priority groups.

According to one aspect of the present application, the above method is characterized in that the second node is a UE.

According to one aspect of the present application, the above method is characterized in that the second node is a relay node.

According to one aspect of the present application, the above method is characterized in that the second node is a Road Side Unit (RSU).

The present application provides a first node for wireless communications, comprising:
a first receiver, receiving first configuration information;
a second receiver, receiving a first candidate signal on a first candidate time-domain resource block; and
a first transmitter, transmitting a first positioning reference signal;
herein, the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

The present application provides a second node for wireless communications, comprising:
a third receiver, receiving first configuration information;
a fourth receiver, receiving a first signaling; and
a second transmitter, transmitting a first candidate signal on a first candidate time-domain resource block;
the second transmitter, transmitting a second positioning reference signal;
herein, the first configuration information is used to indicate a first time-domain resource group, the first time-domain resource group comprising at least one time-domain resource block; the first signaling is used to determine whether the first candidate time-domain resource block belongs to the first time-domain resource group; a transmission timing of the first candidate signal is used to determine a transmission timing of the second positioning reference signal.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a structure diagram of UE positioning according to one embodiment of the present application.

FIG. 6 illustrates a flowchart of radio signal transmission according to one embodiment of the present application.

FIG. 7 illustrates a schematic diagram of a relation between an order of multiple candidate priority groups and second configuration information according to one embodiment of the present application.

FIG. 8 illustrates a schematic diagram of relations among a first candidate signal, a first positioning reference signal and a second positioning reference signal according to one embodiment of the present application.

FIG. 9 illustrates a schematic diagram of a relation between a first positioning reference signal and a first radio signal according to one embodiment of the present application.

FIG. 10 illustrates a structure block diagram of a processing device used in a first node according to one embodiment of the present application.

FIG. 11 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

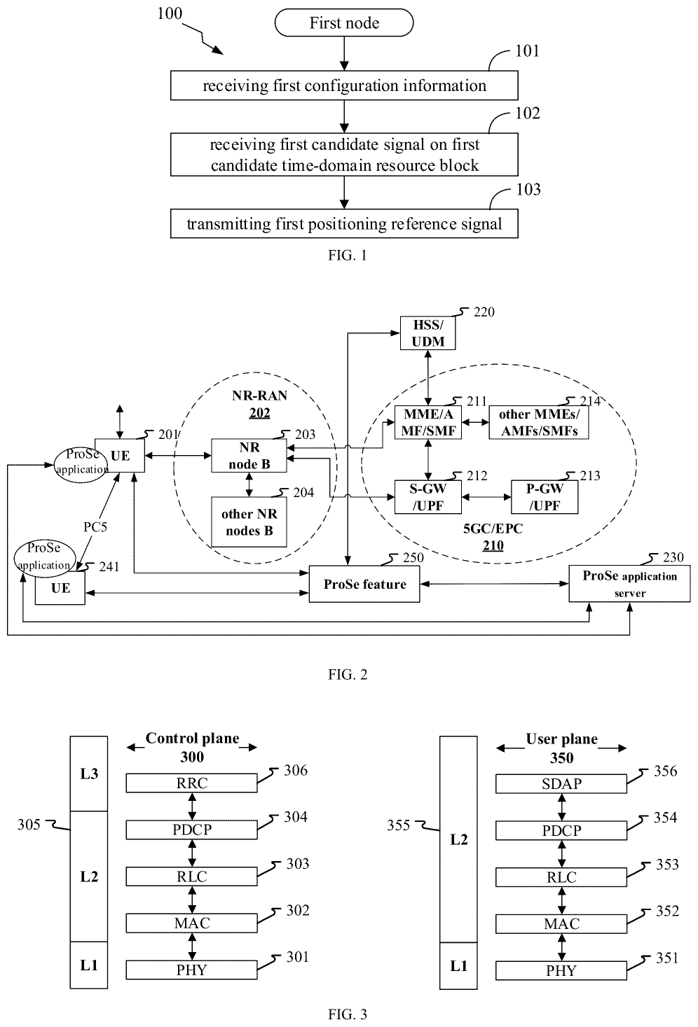

Embodiment 1 illustrates a flowchart of processing of a first node in one embodiment of the present application, as shown in FIG. 1. In FIG. 1, each box represents a step.

In Embodiment 1, a first node in the present application firstly performs step 101 to receive first configuration information; and then performs step 102, to receive a first candidate signal on a first candidate time-domain resource block; and finally performs step 103, to transmit a first positioning reference signal; the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

In one embodiment, the first time-domain resource group comprises at least one time-domain resource block.

In one embodiment, the first time-domain resource group comprises multiple time-domain resource blocks.

In one embodiment, any time-domain resource block in the first time-domain resource group comprises at least one slot.

In one embodiment, any time-domain resource block in the first time-domain resource group comprises at least one Sidelink Slot (SL Slot).

In one embodiment, any time-domain resource block in the first time-domain resource group is a slot.

In one embodiment, any time-domain resource block in the first time-domain resource group is a sidelink slot.

In one embodiment, any time-domain resource block in the first time-domain resource group comprises multiple multicarrier symbols.

In one embodiment, the multiple time-domain resource blocks comprised by the first time-domain resource group are respectively multiple slots.

In one embodiment, any time-domain resource block in the first time-domain resource group is reserved for a Sidelink Synchronization Signal (SLSS).

In one embodiment, any time-domain resource block in the first time-domain resource group is reserved for a Sidelink Synchronization Signal/Physical Sidelink Broadcast Channel block (S-SS/PSBCH block).

In one embodiment, any time-domain resource block in the first time-domain resource group is reserved for a Sidelink Synchronization Signal block (S-SSB).

In one embodiment, any time-domain resource block in the first time-domain resource group is used for transmitting a SLSS.

In one embodiment, any time-domain resource block in the first time-domain resource group is used for transmitting a S-SS/PSBCH block.

In one embodiment, any time-domain resource block in the first time-domain resource group is used for transmitting a S-SSB.

In one embodiment, at least one time-domain resource block in the first time-domain resource group is used for transmitting a S-SS/PSBCH block.

In one embodiment, at least one time-domain resource block in the first time-domain resource group is used for transmitting a S-SSB.

In one embodiment, the first time-domain resource group comprises time-domain resource blocks indicated by sl-SSB-TimeAllocationX, where X is a positive integer.

In one embodiment, the first time-domain resource group comprises slots indicated by sl-SSB-TimeAllocationX, where X is a positive integer.

In one embodiment, any time-domain resource block in the first time-domain resource group is indicated by sl-SSB-TimeAllocationX, where X is a positive integer.

In one embodiment, X is a positive integer greater than 3.

In one embodiment, X is 4.

In one embodiment, the first time-domain resource group is indicated by the first configuration information.

In one embodiment, the first configuration information is used for indicating the first time-domain resource group.

In one embodiment, the first configuration information is used for indicating the at least one time-domain resource block comprised by the first time-domain resource group.

In one embodiment, the first configuration information is preconfigured.

In one embodiment, the first configuration information is configured.

In one embodiment, the first configuration information is configured by a Higher Layer Signaling.

In one embodiment, the first configuration information comprises a Higher Layer Signaling.

In one embodiment, the first configuration information comprises one or more fields in a Radio Resource Control (RRC) layer signaling.

In one embodiment, the first configuration information comprises a Radio Resource Control-Information Element (RRC IE).

In one embodiment, the first configuration information comprises one or more fields in a Multimedia Access Control (MAC) layer signaling.

In one embodiment, the first configuration information comprises a Physical Layer (PHY) signaling.

In one embodiment, the first configuration information comprises a piece of Downlink Control Information (DCI).

In one embodiment, the first configuration information comprises a piece of Sidelink Control Information (SCI).

In one embodiment, the first configuration information is a System Information Block (SIB).

In one embodiment, the first configuration information comprises Sidelink Positioning Configuration.

In one embodiment, the first configuration information comprises Sidelink Communication Configuration.

In one embodiment, the first configuration information comprises Sidelink Discovery Configuration.

In one embodiment, the first configuration information comprises sl-SyncConfig.

In one embodiment, the sl-SyncConfig is an RRC IE.

In one embodiment, the definition of the sl-SyncConfig can be found in 3GPP TS38.331, Section 6.3.5.

In one embodiment, the first configuration information comprises sl-SSB-TimeAllocationX, where X is a positive integer.

In one embodiment, the sl-SSB-TimeAllocationX is a field in an RRC IE.

In one embodiment, the first configuration information comprises a SL-ResourcePool.

In one embodiment, the SL-ResourcePool is an RRC IE.

In one embodiment, the definition of the SL-ResourcePool can be found in 3GPP TS38.331, Section 6.3.5.

In one embodiment, the first configuration information is used for indicating the first resource pool.

In one embodiment, the first configuration information comprises the first resource pool.

In one embodiment, the first configuration information comprises time-domain resources occupied by the first resource pool.

In one embodiment, the first configuration information comprises frequency-domain resources occupied by the first resource pool.

In one embodiment, the first configuration information is used for indicating the multiple time-frequency resource blocks comprised in the first resource pool.

In one embodiment, the first configuration information is used for indicating the multiple time-domain resource blocks comprised by the first resource pool in time domain.

In one embodiment, the first configuration information is used for indicating the multiple frequency-domain resource blocks comprised by the first resource pool in frequency domain.

In one embodiment, the first resource pool comprises the first time-domain resource group in time domain.

In one embodiment, any time-domain resource block in the first time-domain resource group belongs to the first resource pool.

In one embodiment, any time-domain resource block in the first time-domain resource group is one of multiple time-domain resource blocks comprised by the first resource pool in time domain.

In one embodiment, the first resource pool comprises a Sidelink Resource Pool.

In one embodiment, the first resource pool is used for Sidelink Transmission.

In one embodiment, the first resource pool is used for Sidelink Communication.

In one embodiment, the first resource pool is used for Sidelink Positioning.

In one embodiment, the first resource pool is used for Sidelink Positioning Reference Signal (SL PRS/SL-PRS) transmission.

In one embodiment, the first resource pool is dedicated to SL-PRS transmission.

In one embodiment, the first resource pool is used for SL-PRS and Sidelink Control Information (SCI) transmissions.

In one embodiment, the first resource pool comprises a Physical Sidelink Control Channel (PSCCH).

In one embodiment, the first resource pool comprises a Physical Sidelink Shared Channel (PSSCH).

In one embodiment, the first resource pool comprises SL-PRS resources.

In one embodiment, the first resource pool comprises PSCCH and SL-PRS resources.

In one embodiment, the first resource pool comprises PSCCH, PSSCH and SL-PRS resources.

In one embodiment, the first resource pool comprises multiple Resource Elements (REs).

In one embodiment, any RE in the first resource pool occupies a multicarrier symbol in time domain and a subcarrier in frequency domain.

In one embodiment, the first resource pool comprises multiple time-frequency resource blocks.

In one embodiment, any time-frequency resource block among the multiple time-frequency resource blocks comprised in the first resource pool comprises multiple REs.

In one embodiment, the first resource pool comprises multiple time-domain resource blocks in time domain.

In one embodiment, the first resource pool comprises multiple frequency-domain resource blocks in frequency domain.

In one embodiment, time-domain resources occupied by any time-frequency resource block of the multiple time-frequency resource blocks comprised by the first resource pool in time domain are one of the multiple time-domain resource blocks comprised by the first resource pool in time domain.

In one embodiment, time-domain resources occupied by the multiple time-frequency resource blocks comprised by the first resource pool in time domain are respectively the multiple time-domain resource blocks comprised by the first resource pool in time domain.

In one embodiment, frequency-domain resources occupied by any time-frequency resource block of the multiple time-frequency resource blocks comprised by the first resource pool in frequency domain are one of the multiple frequency-domain resource blocks comprised by the first resource pool in frequency domain.

In one embodiment, frequency-domain resources occupied by the multiple time-frequency resource blocks comprised by the first resource pool in frequency domain are respectively the multiple frequency-domain resource blocks comprised by the first resource pool in frequency domain.

In one embodiment, time-domain resources occupied by any time-frequency resource block of the multiple time-frequency resource blocks comprised by the first resource pool in time domain belong to a time-domain resource block in the first resource pool, and frequency-domain resources occupied by any time-frequency resource block of the multiple time-frequency resource blocks comprised by the first resource pool in frequency domain belong to a frequency-domain resource block in the first resource pool.

In one embodiment, the multiple time-domain resource blocks comprised by the first resource pool in time domain are respectively multiple slots.

In one embodiment, the multiple time-domain resource blocks comprised by the first resource pool in time domain are respectively multiple multicarrier symbols.

In one embodiment, any time-domain resource block among the multiple time-domain resource blocks comprised in the first resource pool in time domain belongs to a slot.

In one embodiment, any time-domain resource block among the multiple time-domain resource blocks comprised in the first resource pool in time domain comprises at least one multicarrier symbol.

In one embodiment, the multiple frequency-domain resource blocks comprised by the first resource pool in frequency domain are respectively multiple subchannels.

In one embodiment, the multiple frequency-domain resource blocks comprised by the first resource pool in frequency domain are respectively multiple Resource Blocks (RBs).

In one embodiment, the multiple frequency-domain resource blocks comprised by the first resource pool in frequency domain are respectively multiple Physical Resource Blocks (PRBs).

In one embodiment, any frequency-domain resource block among the multiple frequency-domain resource blocks comprised by the first resource pool in frequency domain belongs to a subchannel.

In one embodiment, any frequency-domain resource block among the multiple frequency-domain resource blocks comprised by the first resource pool in frequency domain belongs to an RB.

In one embodiment, any frequency-domain resource block among the multiple frequency-domain resource blocks comprised by the first resource pool in frequency domain belongs to a PRB.

In one embodiment, any frequency-domain resource block among the multiple frequency-domain resource blocks comprised by the first resource pool in frequency domain comprises at least one subcarrier.

In one embodiment, any frequency-domain resource block among the multiple frequency-domain resource blocks comprised by the first resource pool in frequency domain comprises at least one RB.

In one embodiment, any frequency-domain resource block among the multiple frequency-domain resource blocks comprised by the first resource pool in frequency domain comprises at least one PRB.

In one embodiment, the multiple time-domain resource blocks comprised by the first resource pool in time domain are respectively multiple slots, and the multiple frequency-domain resource blocks comprised by the first resource pool in frequency domain are respectively multiple PRBs.

In one embodiment, the multicarrier symbol is an Orthogonal Frequency Division Multiplexing (OFDM) Symbol.

In one embodiment, the multicarrier symbol is a Single-Carrier Frequency Division Multiple Access (SC-FDMA) symbol.

In one embodiment, the multicarrier symbol is a Discrete Fourier Transform Spread Orthogonal Frequency Division Multiplexing (DFT-S-OFDM) symbol.

In one embodiment, the multicarrier symbol is an Interleaved Frequency Division Multiple Access (IFDMA) symbol.

In one embodiment, the first resource pool comprises the first candidate time-domain resource block.

In one embodiment, the first resource pool comprises the first candidate time-domain resource block.

In one embodiment, the first candidate time-domain resource block is one of the multiple time-domain resource blocks comprised by the first resource pool.

In one embodiment, the first candidate time-domain resource block comprises at least one slot.

In one embodiment, the first candidate time-domain resource block is a slot.

In one embodiment, the first candidate time-domain resource block comprises multiple multicarrier symbols.

In one embodiment, the first candidate time-domain resource block comprises multiple consecutive multicarrier symbols.

In one embodiment, the first candidate time-domain resource block is used for bearing a SLSS.

In one embodiment, the first candidate time-domain resource block is used for bearing a S-SS/PSBCH block.

In one embodiment, the first candidate time-domain resource block is used for bearing a S-SSB.

In one embodiment, the first candidate time-domain resource block belongs to the first time-domain resource group, or, the first candidate time-domain resource block does not belong to the first time-domain resource group.

In one embodiment, the first candidate time-domain resource block belongs to the first time-domain resource group.

In one embodiment, the first candidate time-domain resource block does not belong to the first time-domain resource group.

In one embodiment, the first candidate time-domain resource block belonging to the first time-domain resource group means that the first candidate time-domain resource block is a time-domain resource block in the first time-domain resource group.

In one embodiment, the first candidate time-domain resource block belonging to the first time-domain resource group means that the first candidate time-domain resource block is a time-domain resource block of the at least one time-domain resource block comprised by the first time-domain resource group.

In one embodiment, the first candidate time-domain resource block not belonging to the first time-domain resource group means that the first candidate time-domain resource block is different from any time-domain resource block in the first time-domain resource group.

In one embodiment, the first candidate signal is used for synchronization.

In one embodiment, the first candidate signal is used for sidelink synchronization.

In one embodiment, the first candidate signal comprises a synchronization signal.

In one embodiment, the first candidate signal comprises a broadcast signal.

In one embodiment, the first candidate signal comprises a sidelink synchronization signal.

In one embodiment, the first candidate signal comprises a sidelink broadcast signal.

In one embodiment, the first candidate signal comprises a SLSS.

In one embodiment, the first candidate signal comprises a S-SS/PSBCH block.

In one embodiment, the first candidate signal comprises a S-SSB.

In one embodiment, the first candidate signal comprises a Sidelink Primary Synchronization Signal (S-PSS).

In one embodiment, the first candidate signal comprises a Sidelink Secondary Synchronization Signal (S-SSS).

In one embodiment, the first candidate signal comprises a PSBCH.

In one embodiment, the first candidate signal comprises a PSBCH Demodulation Reference Signal (DMRS).

In one embodiment, the first candidate signal comprises a Sidelink Channel State Information Reference Signal (SL CSI-RS).

In one embodiment, the first candidate signal comprises a Sidelink Phase Tracking Reference Signal (SL PTRS).

In one embodiment, the first candidate signal comprises a SL PRS.

In one embodiment, the measurement result of the first candidate signal comprises a Reference Signal Received Power (RSRP) value based on the first candidate signal.

In one embodiment, the measurement result of the first candidate signal is a linear average value of power contribution on REs bearing the first candidate signal.

In one embodiment, the measurement result of the first candidate signal is a linear average value of power contribution on REs bearing a DMRS associated with a PSBCH.

In one embodiment, the measurement result of the first candidate signal is a linear average value of power contribution on REs bearing a S-SSS.

In one embodiment, the measurement result of the first candidate signal comprises a SL RSRP.

In one embodiment, the measurement result of the first candidate signal comprises a SL RSSI.

In one embodiment, the measurement result of the first candidate signal comprises a PSBCH—RSRP.

In one embodiment, the measurement result of the first candidate signal comprises a measurement result of a PSBCH—RSRP.

In one embodiment, the measurement result of the first candidate signal is measured in Watt (W).

In one embodiment, the measurement result of the first candidate signal is measured in dB.

In one embodiment, the measurement result of the first candidate signal is measured in dBm.

In one embodiment, the first threshold is an RSRP value.

In one embodiment, the first threshold is a non-negative integer.

In one embodiment, the first threshold is a positive integer.

In one embodiment, the first threshold is measured in W.

In one embodiment, the first threshold is measured in dB.

In one embodiment, the first threshold is measured in dBm.

In one embodiment, the first threshold is indicated by a higher layer signaling.

In one embodiment, the first threshold is indicated by sl-SyncRefMinHyst.

In one embodiment, the first threshold is one of 0 dB, 3 dB, 6 dB, 9 dB, or 12 dB.

In one embodiment, the measurement result of the first candidate signal is greater than the first threshold.

In one embodiment, the measurement result of the first candidate signal exceeds the first threshold.

In one embodiment, the synchronization reference for the first positioning reference signal is used to determine a transmission timing of the first positioning reference signal.

In one embodiment, the synchronization reference for the first positioning reference signal is related to a reception timing of the first candidate signal.

In one embodiment, the synchronization reference for the first positioning reference signal comprises a synchronization reference source of the first positioning reference signal.

In one embodiment, the synchronization reference for the first positioning reference signal refers to a synchronization reference source of the first positioning reference signal.

In one embodiment, the synchronization reference for the first positioning reference signal comprises a communication node.

In one embodiment, the synchronization reference for the first positioning reference signal comprises a UE.

In one embodiment, the synchronization reference for the first positioning reference signal comprises the Global Navigation Satellite System (GNSS).

In one embodiment, the synchronization reference for the first positioning reference signal comprises a cell.

In one embodiment, a reception timing of the synchronization reference for the first positioning reference signal is used to determine a transmission timing of the first positioning reference signal.

In one embodiment, a reception timing of receiving a radio signal from the synchronization reference for the first positioning reference signal is used to determine a transmission timing of the first positioning reference signal.

In one embodiment, the synchronization reference for the first positioning reference signal is used to determine a scrambling sequence of the first positioning reference signal.

In one embodiment, the synchronization reference for the first positioning reference signal comprises a scrambling sequence of the first positioning reference signal.

In one embodiment, the transmitter of the first candidate signal is a communication node.

In one embodiment, the transmitter of the first candidate signal is a UE.

In one embodiment, the transmitter of the first candidate signal is GNSS.

In one embodiment, the transmitter of the first candidate signal is a cell.

In one embodiment, the transmitter of the first candidate signal is a target receiver of the first positioning reference signal.

In one embodiment, the transmitter of the first candidate signal is an Anchor Node.

In one embodiment, the transmitter of the first candidate signal is configured.

In one embodiment, the transmitter of the first candidate signal is configured by higher layer signaling.

In one embodiment, the transmitter of the first candidate signal is indicated by a higher layer signaling.

In one embodiment, the transmitter of the first candidate signal is indicated by a physical layer signaling.

In one embodiment, the transmitter of the first candidate signal is indicated by a DCI.

In one embodiment, the transmitter of the first candidate signal is indicated by an SCI.

In one embodiment, whether the first candidate time-domain resource block belongs to the first time-domain resource group is used to determine whether the transmitter of the first candidate signal is selected as the synchronization reference for the first positioning reference signal.

In one embodiment, the transmitter of the first candidate signal is the synchronization reference for the first positioning reference signal.

In one embodiment, the transmitter of the first candidate signal is not the synchronization reference for the first positioning reference signal.

In one embodiment, when the first candidate time-domain resource block belongs to the first time-domain resource group, the transmitter of the first candidate signal is selected as the synchronization reference for the first positioning reference signal; when the first candidate time-domain resource block does not belong to the first time-domain resource group, the transmitter of the first candidate signal is not selected as the synchronization reference for the first positioning reference signal.

In one embodiment, when the first candidate time-domain resource block belongs to the first time-domain resource group, the scrambling sequence of the first positioning reference signal is a first scrambling sequence; when the first candidate time-domain resource block does not belong to the first time-domain resource group, the scrambling sequence of the first positioning reference signal is a second scrambling sequence; the second scrambling sequence is different from the first scrambling sequence.

In one embodiment, the synchronization reference for the first positioning reference signal comprises an index of a scrambling sequence of the first positioning reference signal.

In one embodiment, when the first candidate time-domain resource block belongs to the first time-domain resource group, the index of the scrambling sequence of the first positioning reference signal is a first index; when the first candidate time-domain resource block does not belong to the first time-domain resource group, the index of the scrambling sequence of the first positioning reference signal is a second index; the second index is unequal to the first index.

In one embodiment, the first candidate time-domain resource block belonging to the first time-domain resource group includes that the first candidate time-domain resource block is indicated by the first configuration information.

In one embodiment, the first candidate time-domain resource block belonging to the first time-domain resource group includes that the first candidate time-domain resource block is a time-domain resource block indicated by the first configuration information.

In one embodiment, the first candidate time-domain resource block belonging to the first time-domain resource group includes that the first candidate time-domain resource block is one of at least one time-domain resource block indicated by the first configuration information.

In one embodiment, the first candidate time-domain resource block not belonging to the first time-domain resource group includes that the first candidate time-domain resource block is not indicated by the first configuration information.

In one embodiment, the first candidate time-domain resource block not belonging to the first time-domain resource group includes that the first candidate time-domain resource block is a time-domain resource block not indicated by the first configuration information.

In one embodiment, the first candidate time-domain resource block not belonging to the first time-domain resource group includes that the first candidate time-domain resource block is different from any time-domain resource block of at least one time-domain resource block indicated by the first configuration information.

In one embodiment, the first positioning reference signal is used for Positioning.

In one embodiment, the first positioning reference signal is used for Sidelink Positioning.

In one embodiment, the first positioning reference signal is used for obtaining first Location Information.

In one embodiment, the first positioning reference signal is used for obtaining a Rx-Tx Time Difference.

In one embodiment, the first positioning reference signal is used for obtaining a Sidelink Rx-Tx Time Difference.

In one embodiment, the first positioning reference signal is used for obtaining a UE Rx-Tx Time Difference.

In one embodiment, the first positioning reference signal is used for obtaining a reception timing of the first candidate positioning reference signal.

In one embodiment, the first positioning reference signal is used by a receiver of the first positioning reference signal for obtaining a reception timing of a subframe.

In one embodiment, the first positioning reference signal is used by a receiver of the first positioning reference signal for obtaining a reception timing of a slot.

In one embodiment, the first positioning reference signal is used for Positioning measurement.

In one embodiment, the first positioning reference signal is used for Sidelink positioning measurement.

In one embodiment, the first positioning reference signal is used for obtaining an Angle-of-Arrival (AoA).

In one embodiment, the first positioning reference signal is used for obtaining a Reference Signal Received Power (RSRP).

In one embodiment, the first positioning reference signal is used for obtaining a Reference Signal Received Path Power (RSRPP).

In one embodiment, the first positioning reference signal is used for obtaining a Reference Signal Time Difference (RSTD).

In one embodiment, the first positioning reference signal is used for obtaining a Relative Time of Arrival (RTOA).

In one embodiment, the first positioning reference signal is used for obtaining a SL-RTOA.

In one embodiment, the first positioning reference signal is used for RTT positioning.

In one embodiment, the first positioning reference signal is used for Single-sided RTT positioning.

In one embodiment, the first positioning reference signal is used for Double-sided RTT positioning.

In one embodiment, the first positioning reference signal is configured by a Location Management Function (LMF).

In one embodiment, the first positioning reference signal is configured by a g-Node-B (gNB).

In one embodiment, the first positioning reference signal is configured by a Cell.

In one embodiment, the first positioning reference signal is configured by a UE.

In one embodiment, the first positioning reference signal includes a Sidelink Reference Signal (SL RS).

In one embodiment, the first positioning reference signal includes a Sidelink Positioning Reference Signal (SL PRS).

In one embodiment, the first positioning reference signal includes a Sounding Reference Signal (SRS).

In one embodiment, the first positioning reference signal includes a S-PSS.

In one embodiment, the first positioning reference signal includes a S-SSS.

In one embodiment, the first positioning reference signal includes a PSBCH DMRS.

In one embodiment, the first positioning reference signal includes a SL CSI-RS.

In one embodiment, the first positioning reference signal includes a first sequence.

In one embodiment, the first sequence is used for generating the first positioning reference signal.

In one embodiment, the first sequence is a Pseudo-Random Sequence.

In one embodiment, the first sequence is a Gold sequence.

In one embodiment, the first sequence is a Zadeoff-Chu (ZC) sequence.

In one embodiment, the first positioning reference signal is obtained by the first sequence sequentially through Sequence Generation, Discrete Fourier Transform (DFT), Modulation, Resource Element Mapping, and Wideband Symbol Generation.

In one embodiment, the first positioning reference signal is obtained by the first sequence sequentially through Sequence Generation, Resource Element Mapping and Wideband Symbol Generation.

In one embodiment, the first location information is reported to an LMF.

In one embodiment, the first location information is transmitted to a receiver of the first positioning reference signal.

In one embodiment, the first location information is reported to an LMF by a receiver of the first positioning reference signal.

In one embodiment, the first location information is transmitted to a first node in the present application.

In one embodiment, the first location information is reported to an LMF by the first node in the present application.

In one embodiment, the first location information is used to determine a Round Trip Time (RTT).

In one embodiment, the first location information is used by an LMF to determine an RTT.

In one embodiment, the first location information is used for positioning.

In one embodiment, the first location information is used for Location related measurement.

In one embodiment, the first location information is used for Sidelink positioning.

In one embodiment, the first location information is used to determine a Propagation Delay.

In one embodiment, the first location information is used by the LMF for determining a Propagation Delay.

In one embodiment, the first location information is used for RTT positioning.

In one embodiment, the first location information is used for Single-sided RTT positioning.

In one embodiment, the first location information is used for Double-sided RTT positioning.

In one embodiment, the first location information is used for Multiple-Round Trip Time (Multi-RTT) positioning.

In one embodiment, the first location information comprises a first Rx-Tx Time Difference.

In one embodiment, the first positioning reference signal is measured for obtaining the first Rx-Tx Time Difference.

In one embodiment, the first positioning reference signal is measured for obtaining the first location information.

In one embodiment, the first Rx-Tx Time Difference is used for generating the first location information.

In one embodiment, the first location information comprises location related measurement.

In one embodiment, the first location information comprises a Location estimate.

In one embodiment, the first location information comprises Positioning Assistance Data.

In one embodiment, the first location information comprises TimingQuality.

In one embodiment, the first location information comprises a RxBeamIndex.

In one embodiment, the first location information comprises Rx power information.

In one embodiment, the first location information is used for transferring Non-Access-Stratum-specific (NAS-specific) information.

In one embodiment, the first location information is used for transferring timing information of the clock.

In one embodiment, the Rx power information comprises a Reference Signal Received Power (RSRP) of the first positioning reference signal.

In one embodiment, the Rx power information comprises a Reference Signal Received Path Power (RSRPP) of the first positioning reference signal.

In one embodiment, the Rx power information comprises a RSRP-ResultDiff.

In one embodiment, the Rx power information is measured in dBm.

In one embodiment, the Rx power information is measured in dB.

In one embodiment, the first Rx-Tx Time Difference includes a Reference Signal Time Difference (RSTD).

In one embodiment, the first Rx-Tx Time Difference includes a Sidelink Rx-Tx Time Difference.

In one embodiment, the first Rx-Tx Time Difference includes a UE Rx-Tx Time Difference.

In one embodiment, the first Rx-Tx Time Difference includes a RxTxTimeDiff.

In one embodiment, the first Rx-Tx Time Difference includes a SL-RxTxTimeDiff.

In one embodiment, the first Rx-Tx Time Difference includes a Relative Time of Arrival (RTOA).

In one embodiment, the first Rx-Tx Time Difference includes a SL-RTOA.

### Embodiment 2

Embodiment 2 illustrates a schematic diagram of a network architecture according to one embodiment of the present application, as shown in FIG. 2. FIG. 2 illustrates a V2X communication architecture of 5G New Radio (NR), Long-Term Evolution (LTE), and Long-Term Evolution Advanced (LTE-A) systems. The 5G NR or LTE network architecture may be called a 5G System/Evolved Packet System (5GS/EPS) 200 or other appropriate terms.

The V2X communication architecture in Embodiment 2 may comprise a UE 201, a UE241, an NG-RAN 202, a 5G Core Network/Evolved Packet Core (5GC/EPC) 210, a Home Subscriber Server/Unified Data Management (HSS/UDM) 220, a ProSe feature 250 and ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an Sl/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services. The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID as well as allocating ProSe-restricted code-suffix pool.

In one embodiment, the UE201 and the UE241 are connected by a PC5 Reference Point.

In one embodiment, the ProSe feature 250 is connected to the UE 201 and the UE 241 respectively by PC3 Reference Points.

In one embodiment, the ProSe feature 250 is connected to the ProSe application server 230 by a PC2 Reference Point.

In one embodiment, the ProSe application server 230 is connected with the ProSe application of the UE 201 and the ProSe application of the UE 241 respectively via a PC1 Reference Point.

In one embodiment, the first node in the present application is the UE 201, and the second node in the present application is the UE241.

In one embodiment, the first node in the present application is the UE 241, and the second node in the present application is the UE201.

In one embodiment, a radio link between the UE 201 and the UE 241 corresponds to a sidelink (SL) in the present application.

In one embodiment, a radio link from the UE 201 to the NR Node B is an uplink.

In one embodiment, a radio link from the NR Node B to the UE 201 is a downlink.

In one embodiment, the UE 201 supports SL transmission.

In one embodiment, the UE 241 supports SL transmission.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a Femtocell.

In one embodiment, the gNB203 is a base station supporting large time-delay difference.

In one embodiment, the gNB203 is a RoadSide Unit (RSU).

In one embodiment, the gNB203 includes satellite equipment.

### Embodiment 3

Embodiment 3 illustrates a schematic diagram of an embodiment of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, or RSU in V2X, vehicle-mounted equipment or vehicle-mounted communication module) and a second node (gNB, UE, or RSU in V2X, vehicle-mounted equipment or vehicle-mounted communication module), or between two UEs is represented by three layers, which are: Layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection, and provides support for handover of a first node between second nodes. The RLC sublayer 303 provides segmentation and reassembling of a packet, retransmission of a missing packet via ARQ, as well as support for detections over repeated packets and protocol errors. The MAC sublayer 302 provides mapping between a logical channel and a transport channel and multiplexing of logical channels. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several upper layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first positioning reference signal in the present application is generated by the PHY 301.

### Embodiment 4

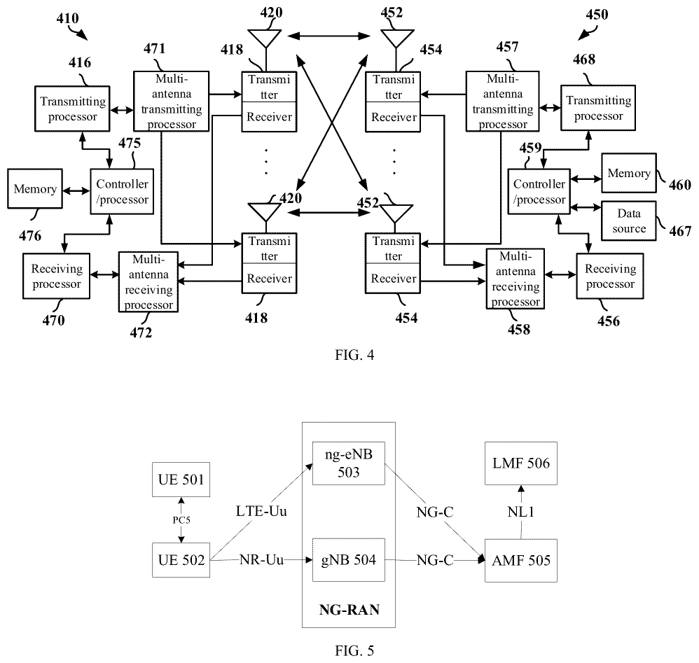

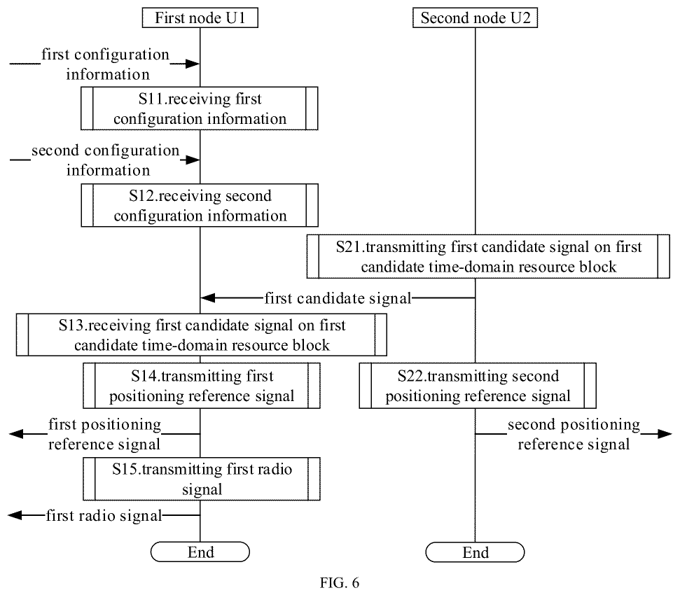

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives first configuration information; receives a first candidate signal on a first candidate time-domain resource block; and transmits a first positioning reference signal; the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

In one embodiment, the second communication device 450 comprises a memory that stores a computer readable instruction program, the computer readable instruction program generates actions when executed by at least one processor, which include: receiving first configuration information; receiving a first candidate signal on a first candidate time-domain resource block; and transmitting a first positioning reference signal; the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: receives first configuration information; receives a first signaling; and transmits a first candidate signal on a first candidate time-domain resource block; and transmits a second positioning reference signal; the first configuration information is used to indicate a first time-domain resource group, the first time-domain resource group comprising at least one time-domain resource block; the first signaling is used to determine whether the first candidate time-domain resource block belongs to the first time-domain resource group; a transmission timing of the first candidate signal is used to determine a transmission timing of the second positioning reference signal.

In one embodiment, the first communication device 410 comprises a memory that stores a computer readable instruction program, the computer readable instruction program generates actions when executed by at least one processor, which include: receiving first configuration information; receiving a first signaling; and transmitting a first candidate signal on a first candidate time-domain resource block; and transmitting a second positioning reference signal; the first configuration information is used to indicate a first time-domain resource group, the first time-domain resource group comprising at least one time-domain resource block; the first signaling is used to determine whether the first candidate time-domain resource block belongs to the first time-domain resource group; a transmission timing of the first candidate signal is used to determine a transmission timing of the second positioning reference signal.

In one embodiment, the second communication device 450 corresponds to the first node in the present application.

In one embodiment, the first communication device 410 corresponds to the second node in the present application.

In one embodiment, the second communication device 450 is a UE.

In one embodiment, the first communication device 410 is a UE.

In one embodiment, the second communication device 450 is an RSU.

In one embodiment, the first communication device 410 is an RSU.

In one embodiment, at least one of the antenna 452, the receiver 454, the multi-antenna receiving processor 458, the receiving processor 456, the controller/processor 459, or the memory 460 is used for receiving first configuration information in the present application.

In one embodiment, at least one of the antenna 452, the receiver 454, the multi-antenna receiving processor 458, the receiving processor 456, the controller/processor 459, or the memory 460 is used for receiving a first candidate signal on a first candidate time-domain resource block in the present application.

In one embodiment, at least one of the antenna 452, the transmitter 454, the multi-antenna transmitting processor 457, the transmitting processor 468, the controller/processor 459, the memory 460 or the data source 467 is used for transmitting a first positioning reference signal in the present application.

In one embodiment, at least one of the antenna 452, the receiver 454, the multi-antenna receiving processor 458, the receiving processor 456, the controller/processor 459, or the memory 460 is used for receiving second configuration information in the present application.

In one embodiment, at least one of the antenna 452, the transmitter 454, the multi-antenna transmitting processor 457, the transmitting processor 468, the controller/processor 459, the memory 460 or the data source 467 is used for transmitting a first radio signal in the present application.

In one embodiment, at least one of the antenna 420, the receiver 418, the multi-antenna receiving processor 472, the receiving processor 470, the controller/processor 475, or the memory 476 is used for receiving first configuration information in the present application.

In one embodiment, at least one of the antenna 420, the receiver 418, the multi-antenna receiving processor 472, the receiving processor 470, the controller/processor 475, or the memory 476 is used for receiving a first signaling in the present application.

In one embodiment, at least one of the antenna 420, the transmitter 418, the multi-antenna transmitting processor 471, the transmitting processor 416, the controller/processor 475 or the memory 476 is used for transmitting a first candidate signal on a first candidate time-domain resource block in the present application.

In one embodiment, at least one of the antenna 420, the transmitter 418, the multi-antenna transmitting processor 471, the transmitting processor 416, the controller/processor 475 or the memory 476 is used for transmitting a second positioning reference signal in the present application.

### Embodiment 5

Embodiment 5 illustrates a structure diagram of UE positioning according to one embodiment of the present application, as shown in FIG. 5.

A UE501 is in communication with a UE502 via a PC5 interface; the UE 502 is in communication with a ng-eNB503 or gNB504 via a Long Term Evolution (LTE)-Uu interface or New Radio (NR)-Uu interface; the ng-eNB503 and the gNB 504 are sometimes called base stations, and they can also be called Next Generation (NG)-Radio Access Network (RAN). The ng-eNB503 and the gNB 504 are connected to an Authentication Management Field (AMF) 505 respectively via a Next Generation (NG)-Control (C) plane; the AMF505 is connected to a Location Management Function (LMF) 506 via a NL1 interface.

The AMF505 receives from another entity, for instance a Gateway Mobile Location Centre (GMLC) or UE, a request for location service associated with a specific UE, or the AMF505 itself decides to start the location service associated with the specific UE; and then the AMF505 sends a location service request to a LMF, e.g., the LMF506; the LMF then processes the location service request, including sending assistance data to the specific UE to assist with UE-based or UE-assisted positioning as well as receiving Location information reported from the UE; after that the LMF will return the result of the location service to the AMF505; if the location service is requested by another entity, the AMF505 will return such result to the entity.

In one embodiment, the network device in the present application includes an LMF.

In one embodiment, the network device in the present application includes a NG-RAN and an LMF.

In one embodiment, the network device in the present application includes a NG-RAN, an AMF and an LMF.

### Embodiment 6

Embodiment 6 illustrates a flowchart of radio signal transmission according to one embodiment of the present application, as shown in FIG. 6. In FIG. 6, a first node U1 and a second node U2 are in communications via an air interface.

The first node U1 receives first configuration information in step S11; and receives second configuration information in step S12; receives a first candidate signal on a first candidate time-domain resource block in step S13; transmits a first positioning reference signal in step S14; and transmits a first radio signal in step S15.

The second node U2 transmits a first candidate signal on a first candidate time-domain resource block in step S21; and transmits a second positioning reference signal in step S22.

In Embodiment 6, the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal; the transmitter of the first candidate signal belongs to a target priority group, the target priority group being one of multiple candidate priority groups; whether the first candidate time-domain resource block belongs to the first time-domain resource group is used to determine a position of the target priority group among the multiple candidate priority groups; the synchronization reference for the first positioning reference signal is selected according to an order of the multiple candidate priority groups; the second configuration information comprises one of a first priority order, a gnss or a gnbEnb; the first priority order is used to determine the order of the multiple candidate priority groups; the transmitter of the first candidate signal includes a target receiver of the first positioning reference signal, or, the transmitter of the first candidate signal includes a transmitter of a second positioning reference signal, the transmitter of the second positioning reference signal being non-co-located with the first node; the first radio signal comprises a first bit block, and a synchronization reference for the first radio signal is different from the synchronization reference for the first positioning reference signal.

In one embodiment, the first candidate signal carries a first identifier, and whether the first identifier is used to determine a position of the target priority group among the multiple candidate priority groups is related to whether the first candidate time-domain resource block belongs to the first time-domain resource group.

In one embodiment, the first candidate signal carries a first identifier and first information, the first information indicating whether the transmitter of the first candidate signal is in coverage; at least one of the first identifier or the first information is used together with whether the first candidate time-domain resource block belongs to the first time-domain resource group to determine a position of the target priority group among the multiple candidate priority groups.

In one embodiment, a target receiver of the first positioning reference signal includes the second node U2.

In one embodiment, a target receiver of the first positioning reference signal does not include the second node U2.

In one embodiment, a target receiver of the first positioning reference signal is the second node U2.

In one embodiment, a target receiver of the first positioning reference signal is not the second node U2.

In one embodiment, the first node U1 and the second node U2 are in communication via a PC5 interface.

In one embodiment, the second node U2 transmits the first Location Information to the first node U1.

In one embodiment, the second node U2 transmits the first Location Information to the first node U1, and the first node U1 reports the location information of the first node U1 to an LMF.

In one embodiment, the second node U2 reports the first Location Information to an LMF.

In one embodiment, the second configuration information is used to indicate the order of the multiple candidate priority groups.

In one embodiment, the second configuration information is used to indicate that the order of the multiple candidate priority groups is the first priority order.

In one embodiment, the second configuration information is used to indicate that the order of the multiple candidate priority groups is a gnss.

In one embodiment, the second configuration information is used to indicate that the order of the multiple candidate priority groups is a gnbEnb.

In one embodiment, the second configuration information is used to indicate that the order of the multiple candidate priority groups is one of the first priority order, a gnss, or a gnbEnb.

In one embodiment, the order of the multiple candidate priority groups is a Synchronization priority order.

In one embodiment, the second configuration information comprises the first priority order.

In one embodiment, the second configuration information comprises a gnss.

In one embodiment, the second configuration information comprises a gnbEnb.

In one embodiment, the second configuration information comprises one of the first priority order, a gnss, or a gnbEnb.

In one embodiment, the second configuration information is used to indicate the first priority order.

In one embodiment, the second configuration information is used to indicate a gnss.

In one embodiment, the second configuration information is used to indicate a gnbEnb.

In one embodiment, the second configuration information is used to indicate one of the first priority order, a gnss, or a gnbEnb.

In one embodiment, the first priority order is used to determine the order of the multiple candidate priority groups.

In one embodiment, the first priority order is related to SL positioning.

In one embodiment, the first priority order refers to SL positioning.

In one embodiment, a name of the first priority order is slPos.

In one embodiment, only when the second configuration information indicates the first priority order will whether the first candidate time-domain resource block belongs to the first time-domain resource group be used to determine the synchronization reference for the first positioning reference signal.

In one embodiment, only when the second configuration information indicates the first priority order will whether the first candidate time-domain resource block belongs to the first time-domain resource group be used to determine whether the transmitter of the first candidate signal is selected as the synchronization reference for the first positioning reference signal.

In one embodiment, only when the second configuration information indicates the first priority order will whether the first candidate time-domain resource block belongs to the first time-domain resource group be used to determine the position of the target priority group among the multiple candidate priority groups.

In one embodiment, the second configuration information is preconfigured.

In one embodiment, the second configuration information is configured.

In one embodiment, the second configuration information is configured by a higher layer signaling.

In one embodiment, the second configuration information comprises a higher layer signaling.

In one embodiment, the second configuration information comprises one or more fields in an RRC layer signaling.

In one embodiment, the second configuration information comprises an RRC IE.

In one embodiment, the second configuration information comprises one or more fields in a MAC layer signaling.

In one embodiment, the second configuration information comprises a PHY signaling.

In one embodiment, the second configuration information comprises a DCI.

In one embodiment, the second configuration information comprises an SCI.

### Embodiment 7

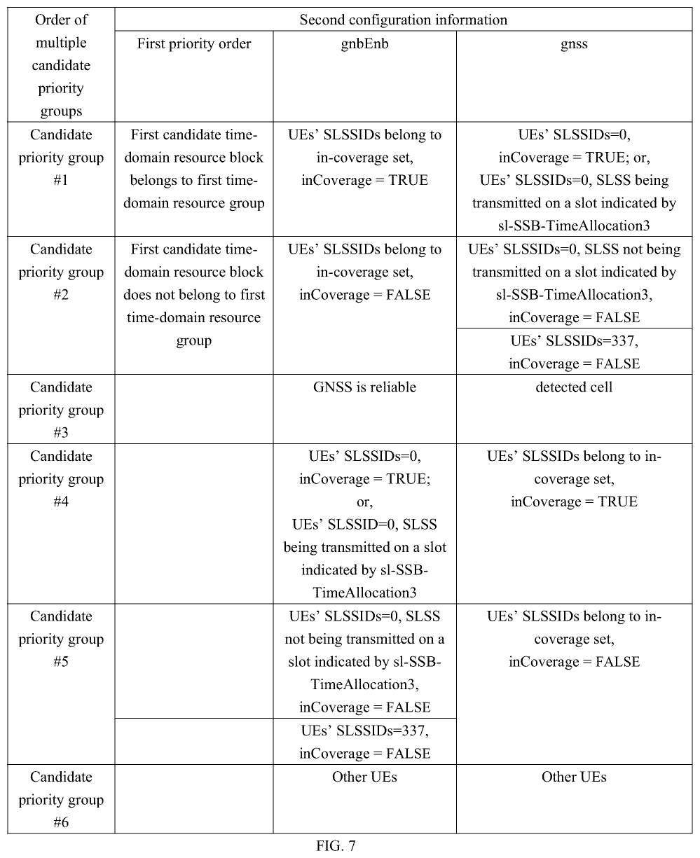

Embodiment 7 illustrates a schematic diagram of a relation between an order of multiple candidate priority groups and second configuration information according to one embodiment of the present application, as shown in FIG. 7.

In Embodiment 7, the transmitter of the first candidate signal belongs to a target priority group, the target priority group being one of multiple candidate priority groups; whether the first candidate time-domain resource block belongs to the first time-domain resource group is used to determine a position of the target priority group among the multiple candidate priority groups; the synchronization reference for the first positioning reference signal is selected according to an order of the multiple candidate priority groups; the first priority order is used to determine the order of the multiple candidate priority groups.

In one embodiment, the multiple candidate priority groups are used to determine the synchronization reference for the first positioning reference signal.

In one embodiment, the synchronization reference for the first positioning reference signal belongs to one candidate priority group among the multiple candidate priority groups.

In one embodiment, the synchronization reference for the first positioning reference signal is selected out of the multiple candidate priority groups.

In one embodiment, the synchronization reference for the first positioning reference signal is selected out of the multiple candidate priority groups according to the order of the multiple candidate priority groups.

In one embodiment, the order of the multiple candidate priority groups is a Synchronization priority order.

In one embodiment, the multiple candidate priority groups are sorted in sequential order, the order of the multiple candidate priority groups referring to the sequential order in which the multiple candidate priority groups are sorted.

In one embodiment, the order of N candidate priority groups refers to candidate priority group #1, candidate priority group #2 . . . , and candidate priority group #N, where N is a positive integer greater than 1.

In one embodiment, a first candidate priority group and a second candidate priority group are any two candidate priority groups among the multiple candidate priority groups, and an order of the first candidate priority group is before an order of the second candidate priority group, the first candidate priority group having a higher priority than the second candidate priority group.

In one embodiment, a first candidate priority group and a second candidate priority group are any two candidate priority groups among the multiple candidate priority groups, and an order of the first candidate priority group is before an order of the second candidate priority group, and any UE in the first candidate priority group has a higher priority than any UE in the second candidate priority group in being selected as the synchronization reference.

In one embodiment, a first candidate priority group and a second candidate priority group are any two candidate priority groups among the multiple candidate priority groups, and an order of the first candidate priority group is before an order of the second candidate priority group, and any UE in the first candidate priority group has a higher priority than any UE in the second candidate priority group in being selected as the synchronization reference for the first positioning reference signal.

In one embodiment, any candidate priority group of the multiple candidate priority groups respectively corresponds to multiple indexes.

In one embodiment, the order of any candidate priority group among the multiple candidate priority groups is an index of the candidate priority group among the multiple candidate priority groups.

In one embodiment, a position of any candidate priority group among the multiple candidate priority groups corresponds to an index of the candidate priority group among the multiple candidate priority groups.

In one embodiment, the smaller an index of any candidate priority group among the multiple candidate priority groups is among the multiple indexes, the higher priority the candidate priority group has among the multiple candidate priority groups.

In one embodiment, the smaller an index of any candidate priority group among the multiple candidate priority groups is among the multiple indexes, the higher priority the candidate priority group has among the multiple candidate priority groups in being selected as a synchronization reference.

In one embodiment, the smaller an index of any candidate priority group among the multiple candidate priority groups is among the multiple indexes, the higher priority the candidate priority group has among the multiple candidate priority groups in being selected as the synchronization reference for the first positioning reference signal.

In one embodiment, the transmitter of the first candidate signal belongs to one of the multiple candidate priority groups.

In one embodiment, the transmitter of the first candidate signal belongs to a target priority group, the target priority group being one of the multiple candidate priority groups.

In one embodiment, a position of the target priority group among the multiple candidate priority groups is used to determine the synchronization reference for the first positioning reference signal.

In one embodiment, a position of the target priority group among the multiple candidate priority groups is used to determine whether the transmitter of the first candidate signal is selected as the synchronization reference for the first positioning reference signal.

In one embodiment, whether the first candidate time-domain resource block belongs to the first time-domain resource group is used to determine a position of the target priority group among the multiple candidate priority groups.

In one embodiment, the position of the target priority group among the multiple candidate priority groups corresponds to an index of the target priority group among the multiple candidate priority groups.

In one embodiment, the position of the target priority group among the multiple candidate priority groups corresponds to an order of the target priority group among the multiple candidate priority groups.

In one embodiment, when the first candidate time-domain resource block belongs to the first time-domain resource group, the target priority group belongs to a first priority group among the multiple candidate priority groups; when the first candidate time-domain resource block does not belong to the first time-domain resource group, the target priority group belongs to a second priority group among the multiple candidate priority groups.

In one embodiment, the first priority group is higher than the second priority group.

In one embodiment, a position of the first priority group among the multiple candidate priority groups is before a position of the second priority group among the multiple candidate priority groups.

In one embodiment, an index of the first priority group among the multiple candidate priority groups is smaller than an index of the second priority group among the multiple candidate priority groups.

In one embodiment, the first candidate signal carries the first identifier.

In one embodiment, the first identifier is used for identifying the transmitter of the first candidate signal.

In one embodiment, the first identifier is used for identifying a UE.

In one embodiment, the first identifier is used for identifying an RSU.

In one embodiment, the first identifier is a non-negative integer.

In one embodiment, the first identifier is a non-negative integer no greater than 671.

In one embodiment, the first identifier is an integer of 0 through 671.

In one embodiment, the first identifier is a SLSSID.

In one embodiment, the first identifier is a sidelink synchronization signal identity.

In one embodiment, the first identifier is used to determine a sidelink synchronization signal.

In one embodiment, the first identifier is used to determine a S-PSS.

In one embodiment, the first identifier is used to determine a S-SSS.

In one embodiment, the first identifier is used to determine a S-SS/PSBCH block index.

In one embodiment, the first identifier is a S-SS/PSBCH block index.

In one embodiment, the first identifier is a Layer 1 (L1) Source ID.

In one embodiment, the first identifier is used to indicate whether a synchronization reference for the transmitter of the first candidate signal is in coverage.

In one embodiment, being in coverage includes being in network coverage, or, selecting GNSS as a synchronization reference source.

In one embodiment, being in coverage includes being in network coverage, or, that GNSS signal is reliable.

In one embodiment, being in coverage includes being in network coverage.

In one embodiment, being in coverage includes that GNSS is reliable.

In one embodiment, being in coverage includes that the signal received from GNSS is reliable.

In one embodiment, being in coverage includes choosing GNSS timing as a synchronization reference source.

In one embodiment, a synchronization reference for the transmitter of the first candidate signal being in coverage includes the synchronization reference for the transmitter of the first candidate signal being in network coverage.

In one embodiment, a synchronization reference for the transmitter of the first candidate signal being in coverage includes that the signal from GNSS received by the synchronization reference for the transmitter of the first candidate signal is reliable.

In one embodiment, the first identifier is used to determine the position of the target priority group among the multiple candidate priority groups.

In one embodiment, the first identifier is used to determine an index of the target priority group among the multiple candidate priority groups.

In one embodiment, the first identifier being used to determine the position of the target priority group among the multiple candidate priority groups includes that whether the first identifier is equal to 0 is used to determine the position of the target priority group among the multiple candidate priority groups.

In one embodiment, the first identifier being used to determine the position of the target priority group among the multiple candidate priority groups includes that whether the first identifier is equal to an integer in an in-coverage set is used to determine the position of the target priority group among the multiple candidate priority groups.

In one embodiment, the in-coverage set comprises multiple integers, when the first identifier is equal to an integer in the in-coverage set, a synchronization reference for the transmitter of the first candidate signal is in coverage.

In one embodiment, the first identifier is not used to determine the position of the target priority group among the multiple candidate priority groups.

In one embodiment, the first identifier is not used to determine an index of the target priority group among the multiple candidate priority groups.

In one embodiment, whether the first identifier is used to determine a position of the target priority group among the multiple candidate priority groups is related to whether the first candidate time-domain resource block belongs to the first time-domain resource group.

In one embodiment, whether the first identifier is used to determine an index of the target priority group among the multiple candidate priority groups is related to whether the first candidate time-domain resource block belongs to the first time-domain resource group.

In one embodiment, whether the first candidate time-domain resource block belongs to the first time-domain resource group is used to determine whether the first identifier is used to determine the position of the target priority group among the multiple candidate priority groups.

In one embodiment, whether the first candidate time-domain resource block belongs to the first time-domain resource group is used to determine whether the first identifier is used to determine the index of the target priority group among the multiple candidate priority groups.

In one embodiment, when the first candidate time-domain resource block belongs to the first time-domain resource group, the first identifier is used to determine the position of the target priority group among the multiple candidate priority groups; when the first candidate time-domain resource block does not belong to the first time-domain resource group, the first identifier is not used to determine the position of the target priority group among the multiple candidate priority groups.

In one embodiment, when the first candidate time-domain resource block belongs to the first time-domain resource group, the first identifier is used to determine the index of the target priority group among the multiple candidate priority groups; when the first candidate time-domain resource block does not belong to the first time-domain resource group, the first identifier is not used to determine the index of the target priority group among the multiple candidate priority groups.

In one embodiment, the first candidate signal carries the first identifier and the first information.

In one embodiment, the first information is used to indicate whether the transmitter of the first candidate signal is in coverage.

In one embodiment, the first information comprises InCoverage.

In one embodiment, the first information comprises an in-coverage indication.

In one embodiment, the first information comprises one of TRUE or FALSE.

In one embodiment, the first information is equal to one of “1” or “0”.

In one embodiment, the transmitter of the first candidate signal being in coverage includes the transmitter of the first candidate signal being in network coverage.

In one embodiment, the transmitter of the first candidate signal being in coverage includes that the signal from GNSS received by the transmitter of the first candidate signal is reliable.

In one embodiment, at least one of the first identifier or the first information is used together with whether the first candidate time-domain resource block belongs to the first time-domain resource group to determine the position of the target priority group among the multiple candidate priority groups.

In one embodiment, the first identifier is used together with whether the first candidate time-domain resource block belongs to the first time-domain resource group to determine the position of the target priority group among the multiple candidate priority groups.

In one embodiment, the first information is used together with whether the first candidate time-domain resource block belongs to the first time-domain resource group to determine the position of the target priority group among the multiple candidate priority groups.

In one embodiment, the first identifier, the first information and whether the first candidate time-domain resource block belongs to the first time-domain resource group are used together to determine the position of the target priority group among the multiple candidate priority groups.

### Embodiment 8

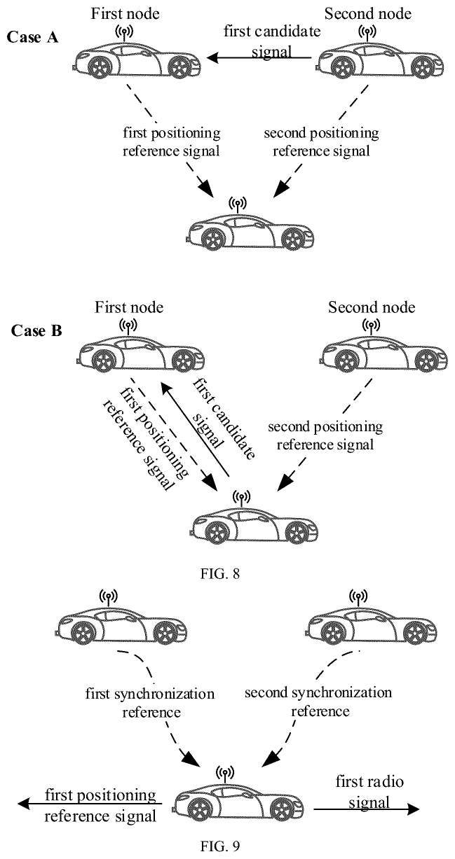

Embodiment 8 illustrates a schematic diagram of relations among a first candidate signal, a first positioning reference signal and a second positioning reference signal according to one embodiment of the present application, as shown in FIG. 8.

In Embodiment 8, the first node transmits a first positioning reference signal, while the second node transmits the second positioning reference signal; In Case A of Embodiment 8, the second node is the transmitter of the first candidate signal; in Case B of Embodiment 8, a target receiver of the first positioning reference signal is the transmitter of the first candidate signal; the second node and the target receiver of the first positioning reference signal are non-co-located.

In one embodiment, the transmitter of the first candidate signal includes the target receiver of the first positioning reference signal.

In one embodiment, the transmitter of the first candidate signal includes the transmitter of the second positioning reference signal.

In one embodiment, the target receiver of the first positioning reference signal includes a UE.

In one embodiment, the target receiver of the first positioning reference signal includes an RSU.

In one embodiment, the transmitter of the second positioning reference signal includes the second node.

In one embodiment, the transmitter of the second positioning reference signal includes a UE.

In one embodiment, the transmitter of the second positioning reference signal includes an RSU.

In one embodiment, the transmitter of the second positioning reference signal and the first node are non-co-located.

In one embodiment, that the second node and the target receiver of the first positioning reference signal are non-co-located includes that: communication delay between the second node and the target receiver of the first positioning reference signal cannot be ignored.

In one embodiment, that the second node and the target receiver of the first positioning reference signal are non-co-located includes that: there exists no wired link between the second node and the target receiver of the first positioning reference signal.

In one embodiment, that the transmitter of the second positioning reference signal and the first node are non-co-located includes that: communication delay between the transmitter of the second positioning reference signal and the first node cannot be ignored.

In one embodiment, that the transmitter of the second positioning reference signal and the first node are non-co-located includes that: there exists no wired link between the transmitter of the second positioning reference signal and the first node.

In one embodiment, the first signaling is used to determine whether the first candidate time-domain resource block belongs to the first time-domain resource group.

In one embodiment, the first signaling is used to indicate whether the first candidate time-domain resource block belongs to the first time-domain resource group.

In one embodiment, the first signaling carries an index of the first candidate time-domain resource block.

In one embodiment, the first signaling comprises an index of the first candidate time-domain resource block.

In one embodiment, the first signaling is a higher layer signaling.

In one embodiment, the first signaling is an RRC signaling.

In one embodiment, the first signaling is a physical layer signaling.

In one embodiment, the first signaling is an SCI.

### Embodiment 9

Embodiment 9 illustrates a schematic diagram of a relation between a first positioning reference signal and a first radio signal according to one embodiment of the present application, as shown in FIG. 9.

In Embodiment 9, the first candidate time-domain resource block belonging to the first time-domain resource group is used to determine that the synchronization reference for the first positioning reference signal is a first synchronization reference; the first radio signal comprises a first bit block, and a synchronization reference for the first radio signal is a second synchronization reference; the second synchronization reference is different from the first synchronization reference.

In one embodiment, the first synchronization reference is a UE.

In one embodiment, the first synchronization reference is an RSU.

In one embodiment, the second synchronization reference is GNSS.

In one embodiment, the second synchronization reference is a cell.

In one embodiment, the second synchronization reference and the first synchronization reference are two different UEs.

In one embodiment, the second synchronization reference and the first synchronization reference are two different RSUs.

In one embodiment, the first synchronization reference is a UE, while the second synchronization reference is an RSU.

In one embodiment, the first synchronization reference is an RSU, while the second synchronization reference is a UE.

In one embodiment, within a first time window, the synchronization reference for the first positioning reference signal is used to determine a transmission timing of the first radio signal.

In one embodiment, within a first time window, the first synchronization reference is used to determine a transmission timing of the first radio signal.

In one embodiment, outside a first time window, the second synchronization reference is used to determine the transmission timing of the first radio signal.

In one embodiment, when the first radio signal is transmitted in the first time window, the synchronization reference for the first positioning reference signal is used to determine the transmission timing of the first radio signal.

In one embodiment, when the first radio signal is transmitted in the first time window, the synchronization reference for the first positioning reference signal is used to determine the transmission timing of the first radio signal; when the first radio signal is transmitted outside the first time window, the second synchronization reference is used to determine the transmission timing of the first radio signal.

In one embodiment, when the first radio signal is transmitted in the first time window, the first synchronization reference is used to determine the transmission timing of the first radio signal; when the first radio signal is transmitted outside the first time window, the second synchronization reference is used to determine the transmission timing of the first radio signal.

### Embodiment 10

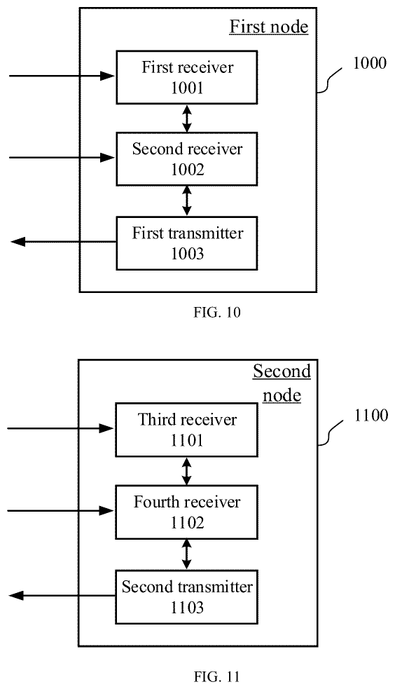

Embodiment 10 illustrates a structure block diagram of a processing device used in a first node, as shown in FIG. 10. In Embodiment 10, a processing device 1000 in a first node is comprised of a first receiver 1001, a second receiver 1002 and a first transmitter 1003.

In one embodiment, the first receiver 1001 comprises at least one of the antenna 452, the transmitter/receiver 454, the multi-antenna receiving processor 458, the receiving processor 456, the controller/processor 459, or the memory 460 in FIG. 4 of the present application.

In one embodiment, the second receiver 1002 comprises at least one of the antenna 452, the transmitter/receiver 454, the multi-antenna receiving processor 458, the receiving processor 456, the controller/processor 459, or the memory 460 in FIG. 4 of the present application.

In one embodiment, the first transmitter 1003 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In Embodiment 10, the first receiver 1001 receives first configuration information; the second receiver 1002 receives a first candidate signal on a first candidate time-domain resource block; and the first transmitter 1003 transmits a first positioning reference signal; the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

In one embodiment, the transmitter of the first candidate signal belongs to a target priority group, the target priority group being one of multiple candidate priority groups; whether the first candidate time-domain resource block belongs to the first time-domain resource group is used to determine a position of the target priority group among the multiple candidate priority groups; the synchronization reference for the first positioning reference signal is selected according to an order of the multiple candidate priority groups.

In one embodiment, the first candidate signal carries a first identifier, and whether the first identifier is used to determine a position of the target priority group among the multiple candidate priority groups is related to whether the first candidate time-domain resource block belongs to the first time-domain resource group.

In one embodiment, the first candidate signal carries a first identifier and first information, the first information indicating whether the transmitter of the first candidate signal is in coverage; at least one of the first identifier or the first information is used together with whether the first candidate time-domain resource block belongs to the first time-domain resource group to determine a position of the target priority group among the multiple candidate priority groups.

In one embodiment, the first receiver 1001 receives second configuration information; the second configuration information comprises one of a first priority order, a gnss or a gnbEnb; the second configuration information is used to determine the order of the multiple candidate priority groups.

In one embodiment, the transmitter of the first candidate signal includes a target receiver of the first positioning reference signal, or, the transmitter of the first candidate signal includes a transmitter of a second positioning reference signal, the transmitter of the second positioning reference signal being non-co-located with the first node.

In one embodiment, the first transmitter 1003 transmits a first radio signal; the first radio signal comprises a first bit block, and a synchronization reference for the first radio signal is different from the synchronization reference for the first positioning reference signal.

In one embodiment, the first node 1000 is a UE.

In one embodiment, the first node 1000 is a relay node.

In one embodiment, the first node 1000 is an RSU.

### Embodiment 11

Embodiment 11 illustrates a structure block diagram of a processing device used in a second node according to one embodiment of the present application, as shown in FIG. 11. In Embodiment 11, a processing device 1100 in a second node is comprised of a third receiver 1101, a fourth receiver 1102 and a second transmitter 1103.

In one embodiment, the third receiver 1101 comprises at least one of the antenna 420, the transmitter/receiver 418, the multi-antenna receiving processor 472, the receiving processor 470, the controller/processor 475 or the memory 476 in FIG. 4 of the present application.

In one embodiment, the fourth receiver 1102 comprises at least one of the antenna 420, the transmitter/receiver 418, the multi-antenna receiving processor 472, the receiving processor 470, the controller/processor 475 or the memory 476 in FIG. 4 of the present application.

In one embodiment, the second transmitter 1103 comprises at least one of the antenna 420, the transmitter/receiver 418, the multi-antenna transmitting processor 471, the transmitting processor 416, the controller/processor 475 or the memory 476 in FIG. 4 of the present application.

In Embodiment 11, the third receiver 1101 receives first configuration information; the fourth receiver 1102 receives a first signaling; the second transmitter 1103 transmits a first candidate signal on a first candidate time-domain resource block; the second transmitter 1103 transmits a second positioning reference signal; the first configuration information is used to indicate a first time-domain resource group, the first time-domain resource group comprising at least one time-domain resource block; the first signaling is used to determine whether the first candidate time-domain resource block belongs to the first time-domain resource group; a transmission timing of the first candidate signal is used to determine a transmission timing of the second positioning reference signal.

In one embodiment, the second node belongs to a target priority group, the target priority group being one of multiple candidate priority groups; a position of the target priority group among the multiple candidate priority groups is related to whether the first candidate time-domain resource block belongs to the first time-domain resource group.

In one embodiment, the first candidate signal carries a first identifier, and whether the first identifier is used to determine the position of the target priority group among the multiple candidate priority groups is related to whether the first candidate time-domain resource block belongs to the first time-domain resource group.

In one embodiment, the first candidate signal carries a first identifier and first information, the first information indicating whether the second node is in coverage; the position of the target priority group among the multiple candidate priority groups is related to at least one of the first identifier or the first information and whether the first candidate time-domain resource block belongs to the first time-domain resource group.

In one embodiment, a first priority order is indicated by second configuration information, and the first priority order is used to determine the order of the multiple candidate priority groups.

In one embodiment, the second node 1100 is a UE.

In one embodiment, the second node 1100 is a relay node.

In one embodiment, the second node 1100 is an RSU.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), GNSS, relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, characterized in comprising:
a first receiver, receiving first configuration information;
a second receiver, receiving a first candidate signal on a first candidate time-domain resource block; and
a first transmitter, transmitting a first positioning reference signal;
wherein the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.

2. The first node according to claim 1, characterized in that when the first candidate time-domain resource block belongs to the first time-domain resource group, the transmitter of the first candidate signal is selected as the synchronization reference for the first positioning reference signal; when the first candidate time-domain resource block does not belong to the first time-domain resource group, the transmitter of the first candidate signal is not selected as the synchronization reference for the first positioning reference signal.

3. The first node according to claim 1, characterized in that the transmitter of the first candidate signal belongs to a target priority group, the target priority group being one of multiple candidate priority groups; whether the first candidate time-domain resource block belongs to the first time-domain resource group is used to determine a position of the target priority group among the multiple candidate priority groups; the synchronization reference for the first positioning reference signal is selected according to an order of the multiple candidate priority groups.

4. The first node according to claim 3, characterized in that when the first candidate time-domain resource block belongs to the first time-domain resource group, the target priority group belongs to a first priority group among the multiple candidate priority groups; when the first candidate time-domain resource block does not belong to the first time-domain resource group, the target priority group belongs to a second priority group among the multiple candidate priority groups; the first priority group is higher than the second priority group, or a position of the first priority group among the multiple candidate priority groups is before a position of the second priority group among the multiple candidate priority groups, or an index of the first priority group among the multiple candidate priority groups is smaller than an index of the second priority group among the multiple candidate priority groups.

5. The first node according to claim 1, characterized in that the first candidate signal carries a first identifier, and whether the first identifier is used to determine a position of the target priority group among the multiple candidate priority groups is related to whether the first candidate time-domain resource block belongs to the first time-domain resource group.

6. The first node according to claim 5, characterized in that when the first candidate time-domain resource block belongs to the first time-domain resource group, the first identifier is used to determine the position of the target priority group among the multiple candidate priority groups; when the first candidate time-domain resource block does not belong to the first time-domain resource group, the first identifier is not used to determine the position of the target priority group among the multiple candidate priority groups.

7. The first node according to claim 5, characterized in that when the first candidate time-domain resource block belongs to the first time-domain resource group, the first identifier is used to determine the index of the target priority group among the multiple candidate priority groups; when the first candidate time-domain resource block does not belong to the first time-domain resource group, the first identifier is not used to determine the index of the target priority group among the multiple candidate priority groups.

8. The first node according to claim 1, characterized in that the first candidate signal carries a first identifier and first information, the first information indicating whether the transmitter of the first candidate signal is in coverage; at least one of the first identifier or the first information is used together with whether the first candidate time-domain resource block belongs to the first time-domain resource group to determine a position of the target priority group among the multiple candidate priority groups.

9. The first node according to claim 1, characterized in comprising:
the first receiver, receiving second configuration information;
wherein the second configuration information comprises one of a first priority order, a gnss or a gnbEnb; the first priority order is used to determine the order of the multiple candidate priority groups.

10. The first node according to claim 1, characterized in that the transmitter of the first candidate signal includes a target receiver of the first positioning reference signal, or, the transmitter of the first candidate signal includes a transmitter of a second positioning reference signal, the transmitter of the second positioning reference signal being non-co-located with the first node.

11. The first node according to claim 1, characterized in comprising:
the first transmitter, transmitting a first radio signal;
wherein the first radio signal comprises a first bit block, and a synchronization reference for the first radio signal is different from the synchronization reference for the first positioning reference signal.

12. The first node according to claim 11, characterized in that when the first radio signal is transmitted in the first time window, the synchronization reference for the first positioning reference signal is used to determine a transmission timing of the first radio signal; when the first radio signal is transmitted outside the first time window, a second synchronization reference is used to determine the transmission timing of the first radio signal, the second synchronization reference being different from the first synchronization reference.

13. A second node for wireless communications, characterized in comprising:
a third receiver, receiving first configuration information;
a fourth receiver, receiving a first signaling; and
a second transmitter, transmitting a first candidate signal on a first candidate time-domain resource block;
the second transmitter, transmitting a second positioning reference signal;
wherein the first configuration information is used for indicating a first time-domain resource group, the first time-domain resource group comprising at least one time-domain resource block; the first signaling is used to determine whether the first candidate time-domain resource block belongs to the first time-domain resource group; a transmission timing of the first candidate signal is used to determine a transmission timing of the second positioning reference signal.

14. The second node according to claim 13, characterized in that the second node belongs to a target priority group, the target priority group being one of multiple candidate priority groups; a position of the target priority group among the multiple candidate priority groups is related to whether the first candidate time-domain resource block belongs to the first time-domain resource group.

15. The second node according to claim 14, characterized in that when the first candidate time-domain resource block belongs to the first time-domain resource group, the target priority group belongs to a first priority group among the multiple candidate priority groups; when the first candidate time-domain resource block does not belong to the first time-domain resource group, the target priority group belongs to a second priority group among the multiple candidate priority groups; the first priority group is higher than the second priority group, or a position of the first priority group among the multiple candidate priority groups is before a position of the second priority group among the multiple candidate priority groups, or an index of the first priority group among the multiple candidate priority groups is smaller than an index of the second priority group among the multiple candidate priority groups.

16. The second node according to claim 13, characterized in that the first candidate signal carries a first identifier, and whether the first identifier is used to determine the position of the target priority group among the multiple candidate priority groups is related to whether the first candidate time-domain resource block belongs to the first time-domain resource group.

17. The second node according to claim 13, characterized in that when the first candidate time-domain resource block belongs to the first time-domain resource group, the first identifier is used to determine the position of the target priority group among the multiple candidate priority groups; when the first candidate time-domain resource block does not belong to the first time-domain resource group, the first identifier is not used to determine the position of the target priority group among the multiple candidate priority groups;
or, when the first candidate time-domain resource block belongs to the first time-domain resource group, the first identifier is used to determine the index of the target priority group among the multiple candidate priority groups; when the first candidate time-domain resource block does not belong to the first time-domain resource group, the first identifier is not used to determine the index of the target priority group among the multiple candidate priority groups.

18. The second node according to claim 13, characterized in that the first candidate signal carries a first identifier and first information, the first information indicating whether the second node is in coverage; the position of the target priority group among the multiple candidate priority groups is related to at least one of the first identifier or the first information and whether the first candidate time-domain resource block belongs to the first time-domain resource group.

19. The second node according to claim 13, characterized in that a first priority order is indicated by second configuration information, and the first priority order is used to determine the order of the multiple candidate priority groups.

20. A method in a first node for wireless communications, characterized in comprising:
receiving first configuration information;
receiving a first candidate signal on a first candidate time-domain resource block; and
transmitting a first positioning reference signal;
wherein the first configuration information is used to indicate a first time-domain resource group, the first time-domain resource group comprising at least one time-domain resource block; a measurement result of the first candidate signal is greater than a first threshold; whether the first candidate time-domain resource block belongs to the first time-domain resource group is used to determine whether a transmitter of the first candidate signal is selected as a synchronization reference for the first positioning reference signal.
